(19) United States
(12) Patent Application Publication
(10) Pub. No.: US 2012/0144417 A1
(43) Pub. Date: Jun. 7, 2012

(54) METHOD AND SYSTEM FOR CONTROLLING CONTENT IN A MULTIMEDIA DISPLAY

(75) Inventors: Aslam Khader, Beaverton, OR (US); Larry Alan Westerman, Portland, OR (US)

(73) Assignee: Ensequence, Inc., Portland, OR (US)

(21) Appl. No.: 12/958,315

(22) Filed: Dec. 1, 2010

(51) Int. Cl. H04N 7/10

(52) U.S. Cl. 725/32

(57) ABSTRACT

A computer system is used to create and distribute a multimedia presentation. At a source, audio-video content and an interactive application are broadcast. At a distributor, the audio-video content and the interactive application are received, and at least one resource of the application is replaced with a replacement resource. The audio-video content and the modified interactive application with the replacement resource are distributed. At a receiver, the audio-video content and the modified interactive application are received, the audio-video content is displayed, and in response to an external signal the interactive application is executed utilizing the replacement resource.

### FIELD OF THE INVENTION

This invention relates generally to the processing of data streamed between computer systems, more specifically to the control of graphics content in a multimedia broadcast environment.

### BACKGROUND OF THE INVENTION

Advertising—the proffering of products to potential consumers—pays for many aspects of modern life. For example, the operating expenses and profits associated with terrestrial broadcast of so-called “commercial” television content are collected in large part from companies and individuals who purchase the right to incorporate short segments of audio-video content into entertainment and news broadcast content. These short segments of advertising content can be subtle or blatant attempts to entice a viewer to purchase an item or support a candidate, to patronize a merchant or contribute to a cause. The advertiser pays the broadcaster for the time slot, the so-called “advertising avail”, during which the audio-video content is broadcast, the cost varying according to the potential size of the audience and the popularity of the program within which the avail occurs. In 2009, advertisers paid an estimated US$48 billion to terrestrial, satellite and cable television distributors for advertising rights. A 30-second advertising avail during the 2010 National Football League Super Bowl cost more than US$2,500,000.

Most television content originates from networks such as ABC or ESPN. Networks create or purchase original content, then broadcast it to cable and satellite operators and local affiliates for further distribution to viewers. Networks also cover most of their expenses by the sale of national advertising rights to advertising avails, the corresponding advertising content being distributed along with the programmatic content. Some portion of the advertising avails within a program are made available to the cable and satellite operators and local network affiliates, who are free to replace the advertising content in the national feed with regional or local advertising content and collect associated advertising fees for the avails.

FIG. 1 demonstrates an example of how the content of a half-hour television program might change between the network and the viewer. A typical 30-minute television comedy might include three program segments for a total of 22 minutes of entertainment content, and three advertising breaks totaling 8 minutes. As originated by the network, the advertising breaks contain national advertising content. In this example, the last minute of the first break, the last 90 seconds of the second break, and the last 30 seconds of the third break are designated as avails for regional and/or local replacement. Any advertising avails intended to be replaced at a regional or local level will typically include advertisements emplaced by the network itself, so that third-party advertisements are not replaced.

In the illustrated example, when the national feed is received by a cable operator, the cable operator replaces the content of the last minute of the first break and one minute of the second break with regional advertising content. The cable operator has sold the avails to regional advertisers who develop the inserted content. The cable operator may also insert content to advertise the cable company itself, in case a local distributor does not take advantage of a local avail. Further in the illustrated example, when the modified national feed is received by the local cable distributor, the local distributor further replaces the content of the last 30 seconds of the second break and the last 30 seconds of the third break with local advertising content. The sale of these latter avails provides income to the local distributor.

Television advertisement avails are not limited to just live or “linear” broadcast program content. The replacement or insertion of advertising content may also occur when program content is served from a video-on-demand (VOD) or other non-linear system. The sale of VOD advertising avails may offset part or all of the cost of providing such services, or may serve as a supplemental profit opportunity in a pay-per-view system. Further, advertising content may be replaced or inserted into program content supplied in a multicast or unicast environment, especially when such advertising content is targeted to a specific class or set of viewers.

Systems for replacing or inserting advertising content are well known in the art. For example, U.S. Pat. No. 7,203,758 “System and method for selective insertion of content into streaming media” describes a system for inserting local advertisement content into avails in live or on-demand broadcasts. The Society of Cable Television Engineers ANSI/SCTE 130 series of specifications deals with the insertion and replacement of audio-video and still image advertising content within linear and non-linear program content, providing “a standardized and extensible message based interface defining a minimal set of cooperating logical services necessary to communicate placement opportunities, placement decisions, and placement related event data necessary for accountability measurement.” All such content is inserted and/or composited into the audio-video program content prior to broadcast or distribution of the program content to receivers.

A highly-desirable capability for advertising is the ability to target specific advertisements to those consumers most likely to respond to or be influenced by the specific advertising content. This is a common feature in web-based advertisement systems, which emplace advertising content into web page content served to one or more users. For example, U.S. Pat. No. 6,487,538 “Method and apparatus for local advertising” describes a system for inserting local advertisement content stored at an internet service provider or proxy server into web pages transmitted to a client. U.S. Pat. No. 7,788,687, “Push advertising model using multiple digital streams” describes a system for inserting multiple advertisements into one or more streams conveyed in parallel with the broadcast programming stream from which an advertisement may be chosen at the receiver based on user profile data.

The development of personal video recorders and the capability to store and replay content within a viewer's home have further advanced the ability to target advertising to specific viewers. Television system operators can extend the ability to emplace specific advertising content into the context of a single household. For example, U.S. Pat. No. 6,029,045 “System and method for inserting local content into programming content” describes a system for transmitting local content to a set-top box where the local content is stored for later insertion into a broadcast stream in place of non-local content. U.S. Pat. No. 6,698,020 “Techniques for intelligent video ad insertion” describes a system that resides and operates in a household for storing, selecting, and inserting advertisements into a video programming feed. U.S. Pat. No. 7,328,448 “Advertisement distribution system for distributing targeted advertisements in television systems” describes a system that operates in a viewer's home to store local advertisement content received over a broadcast stream for later display in replacement for global broadcast content. More complex systems have also been disclosed in the prior art. For example, U.S. Pat. No. 6,912,571 “Method of replacing content” and U.S. Pat. No. 7,516,215 “Device, method, and network system for replacing content” describe a system that monitors content received by a television and based on user input, replaces selected advertisement content with alternate advertisement content.

Another opportunity for advertising in television systems is in the context of a program guide. With the multiplicity of available channels and the complexity inherent in multi-channel systems, a viewer can get lost trying to find a desired network or program. For this reason, most cable and satellite operators provide a guide channel that shows a slowly-revolving textual and/or graphic display of current and near-future content. Such guide channels also provide an advertising opportunity at the regional and local level. For example, U.S. Pat. No. 6,209,129 “Passive television program guide system with local information” describes a system for replacing or augmenting global advertisement content on a scrolling television program guide channel with content local to an area or a user.

Simple scrolling program guides are frustrating to use and inadequate for many viewers. As digital receivers become more sophisticated and capable, operators are increasingly relying on the inherent computational capabilities of integrated receiver/decoder (IRD) and set-top box (STB) devices to execute application programs designed to provide viewers with information on current and up-coming program content. Such interactive program guides provide an opportunity for regional and targeted advertisements. The advertisement content may be as simple as textual content displayed in a portion of the graphics display of the program guide overlay, and as complex as audio-video content played in replacement of the underlying program content. For example, U.S. Pat. No. 6,177,931 “Systems and methods for displaying and recording control interface with television programs, video, advertising information and program scheduling information” and U.S. Pat. No. 7,328,450 “Method and system for displaying targeted advertisements in an electronic program guide” describe a system for storing advertising content in an interactive television system and displaying selected advertising content within an interactive program guide on the television. More complex systems are known in the art that take advantage of the processing capabilities of the IRD or STB to provide more sophisticated control over advertising content. For example, U.S. Pat. No. 6,799,326 and U.S. Patent Application 2006/0288366 each entitled “Interactive television program guide system with local advertisements” describe a system for inserting local advertisement content in place of global advertisement within an interactive television program guide based on specific business rules.

In a national or regional program feed, any individual avail is a singular sales opportunity, since the inserted content is conveyed to a multiplicity of homes. However, the development of highly localized and targeted insertion systems has afforded the ability to subdivide the advertising avail, allowing a small advertiser to insert content into some percentage of the possible presentations for a cost less than the full avail. For regional and local operators, sub-avails expand the market for potential advertisers. For advertisers, sub-avails provide an opportunity to potentially reach a broader audience for the same cost. This technique has been applied in both broadcast and web markets. For example, U.S. Pat. No. 7,136,871, U.S. Pat. No. 7,356,547, U.S. Pat. No. 7,536,316, and U.S. Patent Application 2004/0243623 each entitled “Methods and systems for selectively displaying advertisements” describe a system for scheduling specific advertisement content into advertising avails based upon target criteria, advertising and weights. U.S. Pat. No. 6,009,409 “System and method for scheduling and controlling delivery of advertising in a communications network” describes a system for inserting one of a plurality of advertisements into a particular advertising location in a web page, based on desired user frequency, time frequency, or geometry.

Advertisers, broadcasters and distributors continue to search for methods of enhancing the efficiency and effectiveness of advertising content. An overriding inefficiency in advertising is the fact that nearly all advertising content is distributed to an audience that may or may not be interested in and react to the content. This is particularly true of broadcast advertising, the target audience for which is typically diverse. Advertisers perform market research in an attempt to match the proffered product or service to the expected audience, but any single advertisement will be of interest and appeal to only a fraction of the potential or actual audience. The desire to further target specific audience segments underlies the development of targeted advertisement systems such as those discussed above. A further development in this direction is the exploitation of the computation capabilities of IRD and STB devices to execute software applications that seek to enhance viewer interest in and engagement with the television content. Several national application programming standards, including the Enhanced Television Binary Interchange Format (ETV-BIF) and the Open Cable Application Platform (OCAP) specifications developed by CableLabs (Louisville, Colo.), have afforded the opportunity for national broadcasters to create and distribute interactive television (iTV) applications with program content. These standards allow for the broadcast of application code and resources within a broadcast stream, allowing these applications to transiently be loaded into and executed on STBs that support the associated execution environment. iTV applications are often intended to enhance the entertainment experience, with the goal for the broadcasters of increasing their viewership and hence the rate they can charge for advertising avails within their program content. Advertisers also develop iTV applications to broadcast with their advertising content to increase viewer engagement with the content and to provide further opportunities for engagement with interested prospective customers.

Applications that are developed and distributed at a national level will typically contain content intended to appeal to a broad audience. Some types of applications, such as news feed applications or request-for-information (RFI) applications, may contain information or advertisement content that is relevant to a national audience but which might usefully be replaced with more localized content when delivered to a localized viewing audience.

What is desired is a method and system that allows for the targeting and customization of interactive application content in a broadcast environment.

### SUMMARY OF THE INVENTION

The present invention provides a method and system for creating and distributing a multimedia experience to an audience, in which a portion of the content of an interactive application provided in the experience is modified during distribution.

One aspect of the invention teaches a method for configuring an interactive application for delivery over a network to a viewer. The method comprises, in a first aspect, receiving audio-video content and an interactive application over a network from an upstream broadcaster, where the interactive application has associated therewith at least one original resource. The original resource of the interactive application is then replaced with a first replacement resource, and the audio-video content and interactive application with the first replacement resource are then transmitted downstream through the network to multiple receivers simultaneously.

Another aspect of the invention teaches a system for configuring an interactive application for delivery over a network. The system comprises an interactive application receiver for receiving over a network a transport stream from an upstream broadcaster including an interactive application having a first original resource; a resource replacement system operative to demultiplex the interactive application into component parts, identify the first original resource from the component parts, replace the first original resource with a first replacement resource, and reconstruct the interactive application with the first replacement resource; and an interactive application transmitter for transmitting the reconstructed interactive application with the first replacement resource downstream over the network

In yet another aspect of the invention, a system and methods for creating and distributing a multimedia presentation from a broadcasting environment, including means and steps for selecting audio-video content, selecting an interactive application utilizing at least one resource, and broadcasting the interactive application in conjunction with the audio-video content; in a distribution environment receiving the broadcast audio-video content with the interactive application, replacing at least one resource of the interactive application with a replacement resource, and distributing the audio-video content and the interactive application with the replacement resource; and at a receiver receiving the distributed audio-video content and the interactive application with the replacement resource, displaying the audio-video content, and in response to an external signal executing the interactive application utilizing the replacement resource.

Yet another aspect of the present invention distributes the audio-video content and the interactive application with the first replacement resource to a second distribution environment; in the second distribution environment receiving the broadcast audio-video content with the interactive application and the first replacement resource, replacing the first replacement resource of the interactive application with a second replacement resource, and distributing the audio-video content and the interactive application with the second replacement resource; and at a receiver receiving the distributed audio-video content and the interactive application with the second replacement resource, displaying the audio-video content, and in response to an external signal executing the interactive application utilizing the second replacement resource.

In another aspect of the present invention, not all of the resources are replaced.

In another aspect of the present invention, the utilization of at least two resources of the interactive application is determined by at least one business rule that specifies at least one of the duration, frequency, or ordering of the utilization of at least one resource of the at least two resources.

Another aspect of the present invention describes a system and methods for creating and distributing a multimedia presentation from a video server environment, including means and steps for receiving a request for audio-video content, selecting audio-video content based on the request, optionally selecting advertisement content and inserting the selected advertisement into the selected audio-video content, selecting an interactive application utilizing at least one resource, and broadcasting the interactive application in conjunction with the selected audio-video content; in a distribution environment receiving the broadcast audio-video content with the interactive application, replacing at least one resource of the interactive application with a replacement resource, and distributing the audio-video content and the interactive application with the replacement resource; and at a receiver receiving the distributed audio-video content and the interactive application with the replacement resource, displaying the audio-video content, and in response to an external signal executing the interactive application utilizing the replacement resource.

In a still further embodiment of the present invention, at a receiver distributed audio-video content and an interactive application with a replacement resource is received, the audio-video content is displayed, and in response to an external signal the interactive application is executed utilizing the replacement resource.

In a still further embodiment of the present invention, the external signal is a control signal distributed with the interactive application.

In a still further embodiment of the present invention, the external signal is generated by a viewer.

In a still further embodiment of the present invention, the replacement resource is generated immediately prior to replacement.

### BRIEF DESCRIPTION OF THE DRAWINGS

The preferred and alternative embodiments of the present invention are described in detail below with reference to the following drawings.

FIG. 1 depicts contents of a typical 30-minute broadcast program during successive phases of distribution.

FIG. 2 depicts a schematic of an exemplary distribution system for practicing an aspect of the present invention.

FIG. 3 depicts a logical hierarchy of contents of a typical MPEG transport stream according to a preferred implementation of the invention.

FIG. 4 depicts a block diagram of an exemplary system for replacing content in a broadcast stream according to a preferred implementation of the invention.

FIG. 5 depicts a block diagram showing a logical view of a broadcast data carousel according to a preferred implementation of the invention.

FIGS. 6A and 6B depict two versions of the display of an interactive television application configured according to an operation of the invention.

FIG. 7 depicts a block diagram showing an exemplary case of replacing application content in a broadcast stream according to one aspect of the invention.

FIG. 8 depicts a schematic of an exemplary distribution system for practicing an aspect of the present invention.

FIGS. 9A, 9B, 9C, and 9D depict four versions of the display of an interactive television application configured according to an operation of the invention.

FIG. 10 depicts a block diagram showing exemplary cases of modifying application content in a broadcast stream according to one aspect of the invention.

FIGS. 11A, 11B, and 11C depict three versions of the display of an interactive television application configured according to an operation of the invention.

FIG. 12 depicts a block diagram showing an exemplary case of replacing application content in a broadcast stream according to one aspect of the invention.

FIG. 13 depicts three schematic timelines showing exemplary rules for controlling the use of resource content according to an implementation of the invention.

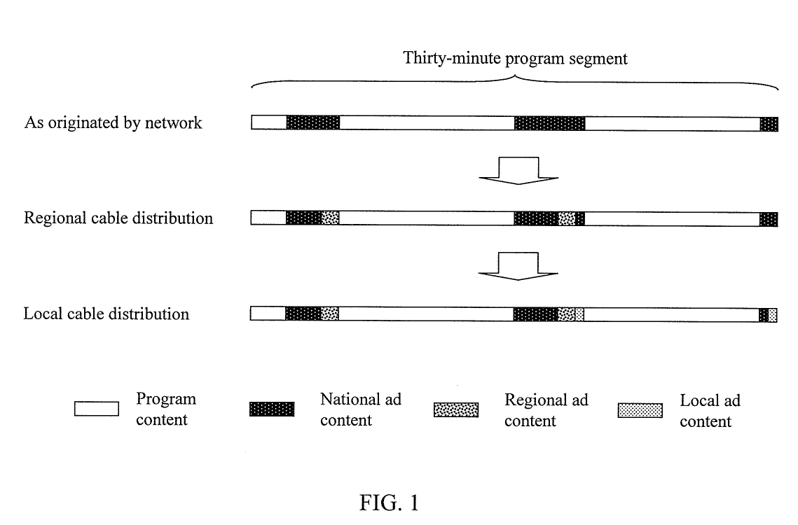

### DETAILED DESCRIPTION OF THE INVENTION

By way of overview, embodiments of the present invention provide a system and methods for creating and distributing a multimedia presentation with a replaced resource to an end user responsive to an external signal.

In one embodiment of the present invention, at a broadcast environment audio-video content and an interactive application utilizing at least one resource are selected and the interactive application is broadcast in conjunction with the audio-video content.

In a still further embodiment of the present invention, at a video server environment a request for audio-video content is received, audio-video content is selected based on the request, advertising content is optionally inserted into the audio-video content, an interactive application utilizing at least one resource is selected, and the interactive application is broadcast in conjunction with the selected audio-video content.

In a still further embodiment of the present invention, at a distribution environment broadcast audio-video content with an interactive application is received, at least one resource of the interactive application is replaced with a replacement resource, and the audio-video content and the interactive application with the replacement resource are distributed.

As used herein the term “program” in conformity with conventional terminology in the television broadcast industry is intended to refer generally to an audio-video presentation originated from a content provider, distributed to viewers, and displayed on an end-user display such as a television, computer, smart phone, tablet computer, or other similar device.

As used herein, the terms “network” and “broadcaster” are intended to refer to an entity or system that creates or acquires program content that may have associated interactive application content; sells and/or trades the rights to advertising avails within the program content; creates and/or receives associated advertising content that may have associated interactive application content for the avails; aggregates the program and advertising content with any associated interactive application content into one or more broadcast content feeds; and supplies the resulting feed or feeds to various other entities which may include inter alia affiliates, cable and satellite distributors, and viewers.

As used herein, the term “video server” is intended to refer to an entity or system that receives a request for audio-video content; selects or accesses stored audio-video content in response to the request; optionally selects advertising content for insertion into the selected audio-video content; selects interactive application content; aggregates the selected audio-video, selected advertising content, and selected interactive application content into one or more broadcast content feeds; and supplies the resulting feed or feeds to a distributor.

As used herein, the term “distributor” is intended to refer to an entity or system that receives broadcast content feeds from one or more sources; sells and/or trades the rights to advertising avails within the received content; creates and/or receives associated advertising content which may have associated interactive application content for inserting into advertising avails; integrates the advertising content and associated interactive application content into the received broadcast content feeds; and supplies the resulting modified broadcast feeds to various other entities which may include inter alia affiliate distributors and viewers.

As used herein, the terms “advertisement” and “advertising” are intended respectively to refer to content and the supplying of content that is supplemental to the primary entertainment or informative content of the medium in which it appears. An advertisement may seek to sell a product, promote an idea or action, supply information, provoke response, or serve some other purpose of general or specific intent. The content of an advertisement may include audio, video, text, and/or still images, and may incorporate the capability for interaction mediated through the display system upon which the primary and advertisement media content are provided. The display system for an advertisement may be static, for example a magazine, newspaper, or billboard; or may be dynamic, for example a radio, motion-picture projector, television, smart phone, personal digital assistant, hand-held video player, game console, or personal computer.

As used herein, the terms “avail” and “advertising avail” are intended to refer to an opportunity for advertisement. In linear or on-demand broadcast context, an avail is a fixed period of time within the temporal flow of a broadcast stream within which advertising content may be inserted or replaced. In a non-broadcast context, an avail is an opportunity in time and/or space for the insertion of advertisement content.

As used herein, the term “sub-avail” is intended to refer to an opportunity for advertisement that may be shared among two or more advertisers, whereby the advertising content of any single advertiser is shown at some but not all of the available occurrences or temporal duration of the advertising opportunity.

As used herein, the term “application” is intended to refer generally to an experience of appearance and behavior engendered by a computing platform. An application is commonly authored in a source code language using an authoring environment, the source code being used to generate an executable version of the application for deployment to a computing platform to realize the desired experience.

As used herein, the term “executable application” is intended to refer to a body of digital information comprising executable instructions and data that when processed on a suitable computing platform yields appearance and behavior as intended by the creator of the application. An executable application may be encoded using native CPU instructions, interpreted byte codes, declarative data structures, or any combination of such encodings. An executable application may respond to external events by appropriate modification of appearance and behavior, as specified by the code and data comprising the executable application.

As used herein, the term “resource” is intended to refer to a body of binary data, exclusive of the source code or executable instructions of an application, which is used during the execution of the application to control the appearance or behavior of the application. A “resource set” is a collection of one or more resources used by an application.

As used herein, the term “module” is intended to refer to a body of binary data that contains all or some portion of the executable instructions and/or resource content of an application.

As used herein, the term “interactive application content” is intended to refer to the instructions and data encoding an executable application, along with any associated resources used by the application, intended for broadcast to and execution upon an IRD or STB. In a broadcast environment, interactive application content may include time-dependent content that provides time-dependent data to an application and/or causes a change in application state.

As used herein, the term “broadcast” is intended to refer to the distribution of analog or digital content through any wired or wireless means wherein the content is intended to be received and utilized by a multiplicity of receivers. Broadcast content may be distributed through terrestrial broadcast; a satellite or cable-based digital or analog data broadcast system; a digital data broadcast system that uses a computer network such as the Internet; a wireless cable broadcast system using for example microwave transmission; a public switched telephone network; or other analog or digital communication network.

As used herein, the terms “integrated receiver decoder” (IRD) and “set-top box” (STB) are intended to refer to a device capable of receiving and decoding analog and/or digital broadcast signals containing audio, video, data, signals, and integrated application content. An STB is conventionally distinct from a television receiver to which it is connected and to which it conveys the decoded audio-video content with any overlaid graphics content. An IRD may be separate from or may be incorporated into a television display device.

As used herein, the term “external signal” is intended to refer to a signal that is distinct from an executable content of an application, that is initiated external to the IRD or STB upon which an application is executed, and that is required for the commencement or continuation of execution of an executable application. The signal may be initiated by the presence of transient or persistent data in a broadcast stream, by an action of a viewer, or by other means known in the art.

The various aspects of the claimed subject matter are now described with reference to the annexed drawings. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

Furthermore, the disclosed subject matter may be implemented as a system, method, apparatus, or article of manufacture using standard programming and/or engineering techniques to produce software, firmware, hardware, or any combination thereof to control a computer or processor based device to implement aspects detailed herein. The term “article of manufacture” (or alternatively, “computer program product”) as used herein is intended to encompass a computer program accessible from any computer-readable device, carrier, or media. Additionally it should be appreciated that a carrier wave can be employed to carry computer-readable electronic data such as those used in transmitting and receiving electronic mail or in accessing a network such as the Internet or a local area network. Of course, those skilled in the art will recognize many modifications may be made to this configuration without departing from the scope or spirit of the claimed subject matter.

Application Distribution and Modification

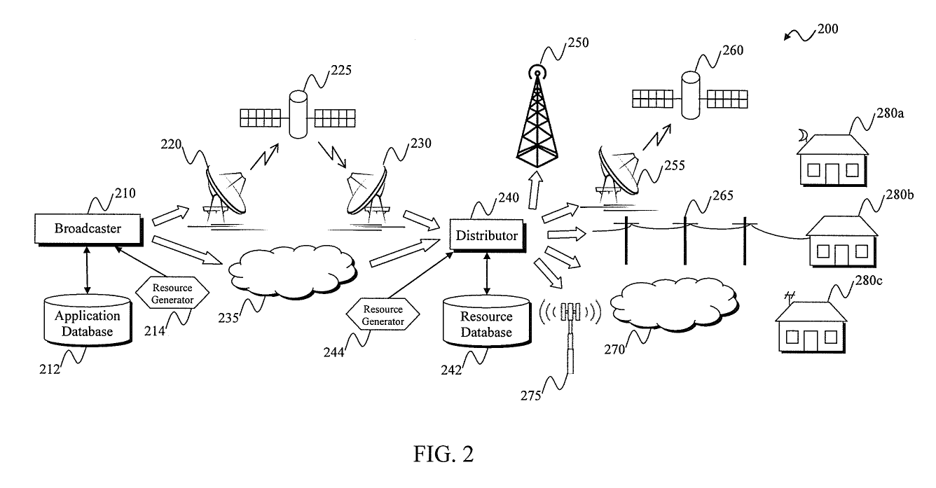

An overview of the inventive method and system are now provided with reference to FIG. 2, which depicts components of an exemplary system 200 configured to practice an aspect of the inventive method. A broadcaster 210 creates a broadcast feed containing program and advertisement content. The broadcaster selects an interactive application from application database 212 for inclusion into the broadcast feed in conjunction with a specific program or advertisement. Application resources included in the interactive application content are selected to be appropriate for a broad general audience. Application resources may be pre-generated, stored in application database 212, and retrieved from application database 212 for incorporation into the broadcast feed. Alternatively or additionally, application resources may be generated by resource generator 214 at the time of broadcast for incorporation into the broadcast feed. The resulting broadcast feed, containing program, advertisement, and interactive application content, may be conveyed to a satellite ground transmitter 220 for conveyance to satellite 225 and thence to satellite ground receiver 230 for receipt by a distributor 240. Alternatively or additionally the broadcast feed may be distributed through wired or wireless network 235 to distributor 240. The broadcast feed may be supplied to distributor 240 as a unitary stream through a single broadcast means, or may be supplied to distributor 240 through multiple broadcast means as multiple sub-streams that are aggregated into a unitary stream by distributor 240.

Distributor 240 receives the broadcast feed, and selects one or more application resources from interactive application content for replacement. Distributor 240 selects pre-generated replacement resources from resource database 242 and modifies the broadcast feed to incorporate the replacement resources. Alternatively or additionally, distributor 240 receives newly-generated replacement resources from resource generator 244 for incorporation into the broadcast feed. The modified broadcast feed may be subsequently broadcast through terrestrial broadcast means 250; may be conveyed to satellite ground transmitter 255 for transmission to satellite 260 whence it is re-broadcast to ground receivers; may be conveyed through wired cable distribution means 265; may be conveyed over wired or wireless network means 270; and may be conveyed through mobile device communication means 275. The modified broadcast feed may be broadcast as a unitary stream through a single broadcast means, or may be broadcast through multiple broadcast means as multiple sub-streams for aggregation at the receiver. The modified broadcast feed is conveyed through one or more broadcast means to viewer homes 280a, 280b, 280c and/or other fixed or mobile receiver sites at which the program, advertising, and interactive application content are received, decoded, and utilized for entertainment, informative, and other purposes.

The functions of application database 212 and resource database 242 may be provided by a single database system. The functions of resource generator 214 and resource generator 244 may be provided by a single resource generator system. Furthermore, the functions of application database 212, resource database 242, resource generator 214 and resource generator 244 may be combined into a single application and resource provisioning system capable of storing and retrieving applications and application resources as well as generating application resources at broadcast time. Such retrieval and generation may be performed in response to command input from broadcaster 210 and distributor 240, and may be performed according to business rules stored in the provisioning system or communicated to the provisioning system by broadcaster 210, distributor 240, or an external party. The communication between broadcaster 210 and resource generator 214 and between distributor 240 and resource generator 244 may be in accordance with a standard protocol such as that defined by the ANSI/SCTE 130 Digital Program Insertion—Advertising Systems Interfaces specifications published by the Society of Cable Telecommunications Engineers, Inc., Exton, Pa.

By way of example, an application configured for distribution, modification and execution in conformance with an aspect of the current invention might consist of a single module comprising the executable code of the application and including image and data resource content. An original version of this module may be stored in application database 212 from which it is retrieved by broadcaster 210 for broadcast to distributor 240. At distributor 240, database 242 may contain one or more alternative replacement versions of the module, and one replacement version of the module may be selected and substituted in the broadcast stream during the broadcast of the application. Further by way of example, an application configured for distribution, modification, and execution in conformance with the current invention might consist of a module comprising the executable code of the application, a module comprising data utilized by the application, and an image resource module utilized by the application. The executable module and the image resource module may be stored in the application database 212, while the data module may be generated at the time of distribution by resource generator 214 using information appropriate to the time and circumstances of the broadcast. One or more replacement image resource modules may be stored in resource database 242, and a replacement data module may be generated at resource generator 244 from information appropriate to the time and circumstances of the distribution. A selected replacement image resource module retrieved from resource database 242 and a replacement data module generated at resource generator 244 may be substituted in the broadcast stream at distributor 240 during the broadcast of the application. The choice of the replacement image resource and the content of the replacement data module may be determined by criteria relevant to the time and circumstances at the distribution. For example, the sale of an advertising avail to a particular advertiser may prompt selection of an image showing the logo of the advertiser and may prompt generation of text data describing a featured product or service offering available from the advertiser.

Distributor 240 may receive broadcast feeds from a number of broadcasters 210, through a variety of communication means. Distributor 240 may perform additional modifications to broadcast feeds including inter alia inserting and/or replacing program, advertising, and interactive application content; and may buffer or store a broadcast feed for a delay period prior to modification and distribution.

Application Transport Encoding

An exemplary implementation of the inventive method and system may utilize the MPEG encoding standard for the conveyance of audio, video and data content. International standard ISO/IEC 13818-1:2000 “Information technology—Generic coding of moving pictures and associated audio information: Systems” defines the digital protocol for conveyance of MPEG-encoded content in transport streams.

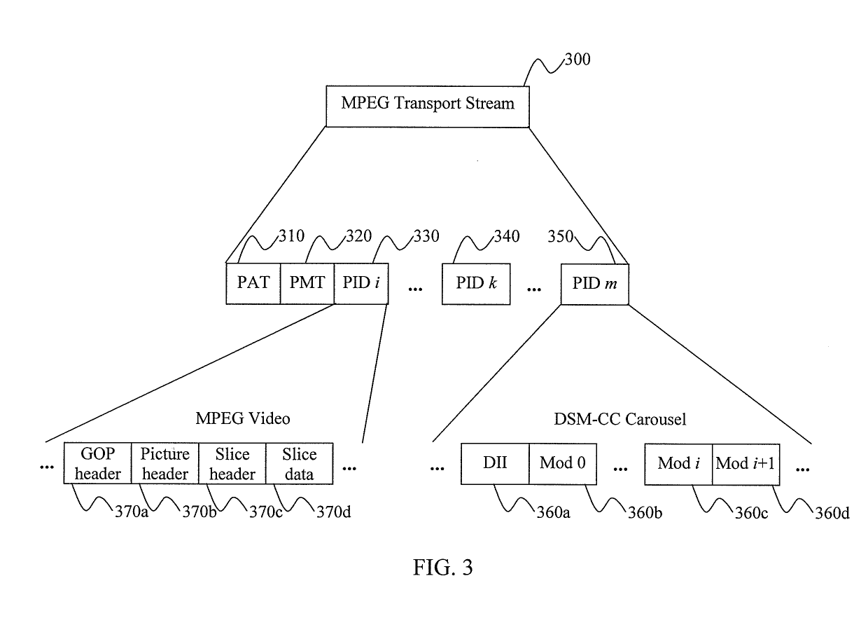

FIG. 3 depicts a hierarchical view of the makeup of a typical MPEG transport stream 300. Those skilled in the art will recognize that this figure depicts a logical organization of the streaming content; the actual streaming content of a compliant MPEG transport stream (TS) is comprised of 188-byte packets that encapsulate the data comprising the various elements, and the contents of each element of a transport stream are defined and conveyed in a linear temporal sense, with some elements constantly changed, other elements repeating, and yet further elements evolving throughout the duration of the stream.

Each packet of data in an MPEG TS contains a 13-bit packet identifier (PID), and successive packets with matching PIDs form a packetized elementary stream (PES). Every compliant MPEG TS contains a Program Association Table (PAT) conveyed in the PES conveyed with PID 0. In exemplary MPEG TS 300 PAT 310 defines the location (PID number) of the PES containing the Program Mapping Table (PMT). The PAT and PMT are part of the program specific information (PSI) content of the TS. PMT 320 in turn defines the identities of the various programs conveyed in the transport stream, and supplies the mapping among the various components such as video, audio and data comprising a program. Each component is conveyed in a PES associated with a single PID. The packets comprising the various tables and elementary streams are interleaved according to the timing requirements of each specific table or stream. Additionally, null packets may be inserted to maintain a required packet rate. At a receiver, packets must be filtered by PID and aggregated within the receiver during the demultiplexing and decoding process.

The exemplary MPEG TS 300 depicted in FIG. 3 includes a program comprising an MPEG video PES 330 conveyed in PID i, an MPEG audio PES 340 conveyed in PID k, and interactive application content 350 conveyed in PID m.

A segment of an MPEG video PES 330 may include a Group of Pictures (GOP) header 370a, a Picture header 370b, a Slice header 370c, and Slice data 370d. These and other components of MPEG-encoded video data will repeat through the broadcast of an MPEG TS.

Interactive application content 350 may be conveyed through a DSM-CC carousel as defined by ISO/IEC 13818-6:1998 “Information technology—Generic coding of moving pictures and associated audio information—Part 6: Extensions for DSM-CC”. A DSM-CC carousel may comprise a DownloadInfoIndicator 360a that conveys the identity and location of various modules 360b, 360c, 360d that contain the code, data and resources of the application.

An MPEG TS may also include an Application Information Table (AIT) and an Extended Application Information Table (XAIT) that convey information about applications encoded in the TS. Other tables may convey the service information (SI) for the stream.

Those skilled in the art will recognize that the depiction in FIG. 3 is only one representation of an MPEG TS, and that other representations and other implementations of the MPEG TS and other broadcast standards may be utilized to convey the contents of a multimedia presentation. For example, the CableLabs ETV-BIF binary encoding standard OC-SP-ETV-BIF1.0-105-091125 specifies how ETV-BIF application code and resources are encoded for inclusion in a broadcast stream, and companion application messaging standard OC-SP-ETV-AM1.0405-091125 specifies that ETV-BIF application signals, triggers and application resources are conveyed in private sections identified by appropriate descriptors encoded in PMT program map sections. ETV-BIF application signals may cause a change in application state of an ETV-BIF application such as loading, running, or termination. ETV-BIF triggers may provide time-dependent data to an ETV-BIF application. As a further example, the OpenCable Application Platform Specifications OCAP1.1 Profile OC-SP-OCAP1.1.3-100603 defines a Java-based application execution environment that can be used for encoding, distributing and executing iTV applications.

Application Resource Substitution

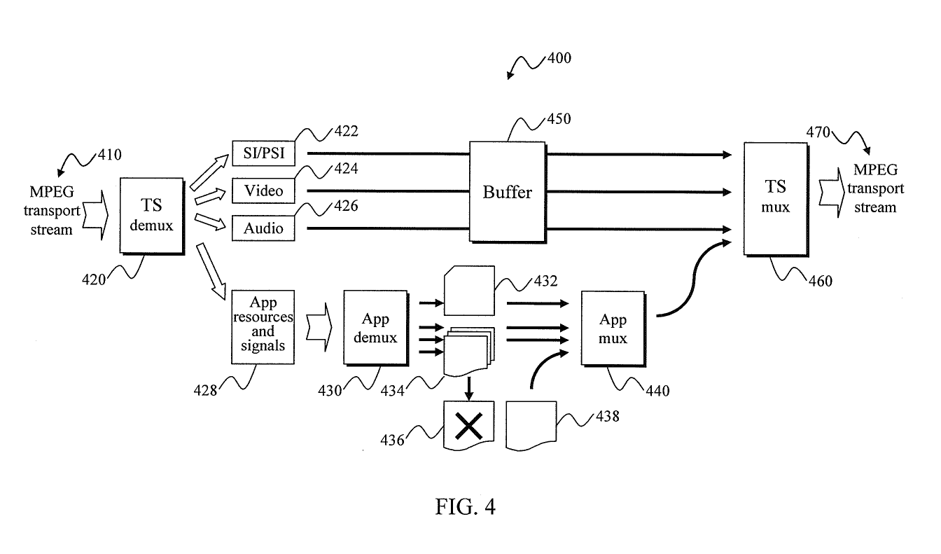

FIG. 4 shows components of an exemplary system 400 configured to perform resource substitution in accordance with an aspect of the present invention. MPEG transport stream 410 is received by a transport stream demultiplexer 420, which acts to separate the various packetized elementary streams comprising the TS including inter alia service information SI and program specific information PSI stream(s) 422, video stream 424, audio stream 426, and application resources and signals 428. Streaming data 428, comprising the application resources and signals, are further fed to an application demultiplexer 430 which separates the data into application signals 432 and various application modules 434. In this exemplary case a single resource 436 has been identified for replacement, so the broadcast content corresponding to this resource is discarded and a replacement resource 438 is substituted. The modified components of the application resources and signals are conveyed to application multiplexer 440 which reconstructs the required PES data. Because of the processing delays introduced by the application demultiplexing/substitution/multiplexing steps, SI/PSI 422, video 424 and audio 426 PES data may be transiently stored in a buffer 450 to accommodate synchronization requirements between these components and the modified application PES data. The SI/PSI stream(s) 422, video stream 424, and audio stream 426, together with the modified application resources and signals, are conveyed to TS multiplexer 460 that reconstructs a compliant modified MPEG transport stream 470. An exemplary device that can be configured to perform the actions of resource substitution system 400 is the ETV TSProcessor™ system manufactured by Strategy & Technology Ltd. of London UK.

FIG. 4 depicts an exemplary system for replacing resources when application signals and resources are transmitted as a unitary stream with audio-video content. In an alternative embodiment of the inventive method and system, application signals 432 and application modules 434 may not be streamed with audio-video content but may be conveyed as a separate sub-stream from broadcaster 210 (FIG. 2) to distributor 240, with resource replacement and application multiplexing taking place at distributor 240, thus eliminating the need for TS demultiplexer 420 and application demultiplexer 430 processing.

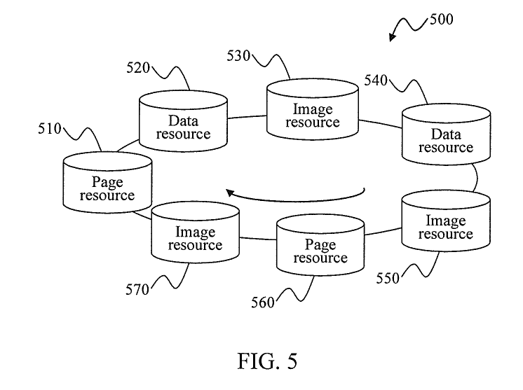

To further clarify the process of resource replacement, FIG. 5 depicts a logical view of the contents of an exemplary DSM-CC carousel 500 conveying the various resources for an ETV-BIF application. The various modules comprising carousel 500 are repeatedly broadcast over time, leading to the notion of a rotating carousel. Those skilled in the art will recognize that individual modules may be repeated with differing frequencies, and the contents of individual modules may change during broadcast of the carousel, so that the carousel need not be conveyed by an unchanging repetition of the same packet sequence over time.

Each ETV-BIF application comprises at least one page resource 510, and may include one or more additional page resource 560. A page resource contains declarative data specifying the initial appearance of one or more pages of the application, and may include executable code and numeric, string, image, or font data for use within the application. A page resource may further reference one or more data resources 520, 540 that contain numeric, string, image, or font data for use by the application. A page resource may use one or more image resources 530, 550, 570 that each contain a single graphical image for display as part of the graphical output of the interactive application. According to the teachings of the inventive method, one or more of the page, data or image resources may be selected for replacement, with the contents of the replacement resource being utilized in the execution of the application. The module complement depicted in FIG. 5 is an exemplary but not limiting depiction of the resource organization of an iTV application suitable for deployment and modification by the inventive method and system.

According to an aspect of the inventive method and system, a page, data or image resource of an ETV-BIF application placed in the carousel at a broadcaster site may be replaced with a modified or replacement page, data or image resource respectively at a distributor site. According to a further aspect of the inventive method and system, a signal conveying timely application data to an application may be replaced with a modified or replacement signal conveying modified or replacement timely application data to the application.

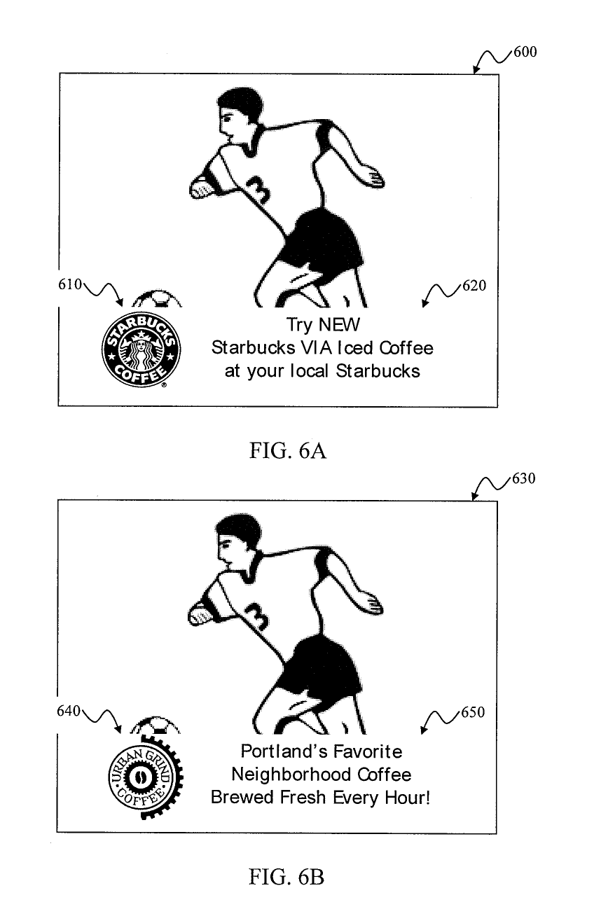

An aspect of the inventive method and system is illustrated in FIG. 6A and FIG. 6B which depict two versions of a display image created by an exemplary ETV-BIF iTV application. The exemplary application displays streaming video program content with a graphical overlay in the bottom portion of the television screen, the graphic overlay comprising an image and text. FIG. 6A depicts a first version 600 of the application with image content 610 and text content 620, while FIG. 6B depicts a second version 630 of the application with image content 640 and text content 650.

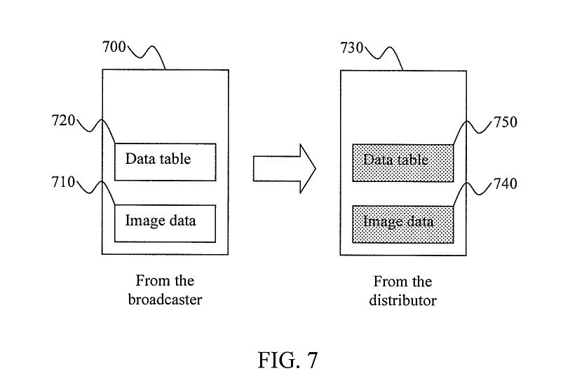

FIG. 7 depicts an exemplary encoding of the interactive application depicted in FIG. 6A and FIG. 6B. The application is encoded in a single module. The original form of the module 700 contains original image data 710 and text data encoded in generic data table 720, corresponding to image content 610 and text content 620 respectively. This version of the module is retrieved by broadcaster 210 from application database 212 and broadcast to distributor 240. If this version of the module is received and executed at a STB the display shown in FIG. 6A is produced. At distributor 240 a replacement module 730 is retrieved from resource database 242. The replacement module 730 contains replacement image data 740 and replacement generic data table 750 encoding replacement text data for the application. The replacement image and data table content correspond to image content 640 and text content 650 respectively. If this version of the module is received and executed at a STB the display shown in FIG. 6B is produced.

Application Modification by Distributors

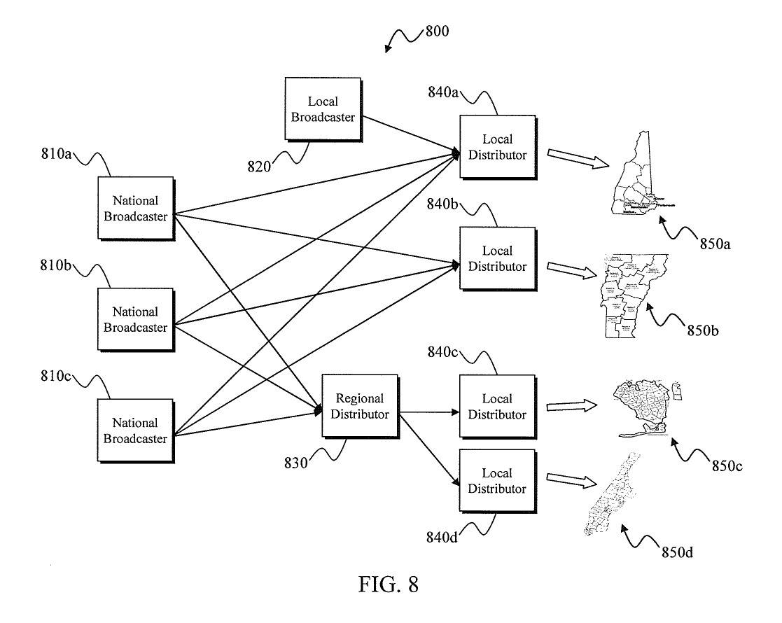

A further embodiment of the inventive method and system is shown in FIG. 8 which depicts components of an exemplary system 800 configured to practice an aspect of the inventive method. National broadcasters 810a, 810b, 810c provide broadcast feeds to regional distributor 830 and local distributors 840a, 840b. Local broadcaster 820 provides a broadcast feed to local distributor 840a. Regional distributor 830 provides broadcast feeds to local distributors 840c, 840d. Local distributors 840a, 804b, 840c, 840d provide broadcast feeds to their respective local service areas 850a, 850b, 850c, 850d.

Each broadcast 810a, 810b, 810c, 820 creates one or more broadcast feeds containing program and advertising content. A broadcaster may select an interactive application for inclusion into a broadcast feed in conjunction with a specific program or advertisement. For national broadcasters 810a, 810b, 810c, application resources included in the interactive application content are selected to be appropriate to a broad national audience. For local broadcaster 820, application resources included in the interactive application content are selected to be appropriate to a local service area.

A regional distributor 830 or a local distributor 840a, 840b, 840c, 840d may perform resource replacement in a broadcast stream. If a regional distributor 830 performs resource replacement in a broadcast stream forwarded to a local distributor 840c, 840d, the local distributor 840c, 840d may also perform resource replacement in the broadcast stream before distributing the modified stream to the local service area. The resource replacement performed by local distributor 840c, 840d may include further replacement of resources replaced by regional distributor 830 and/or may include replacement of resources not replaced by regional distributor 830.

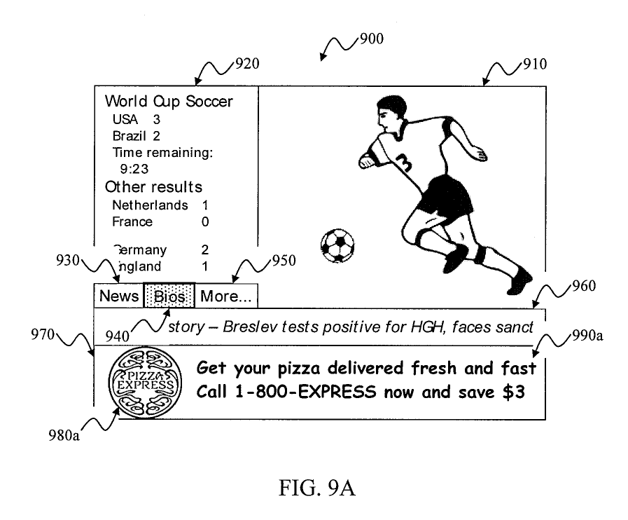

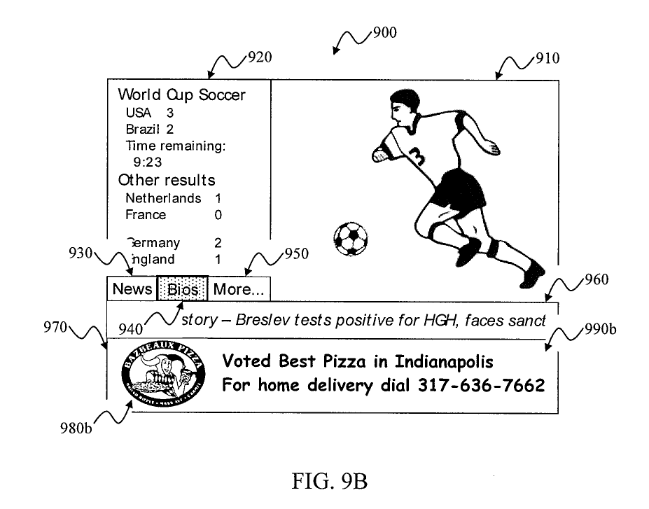

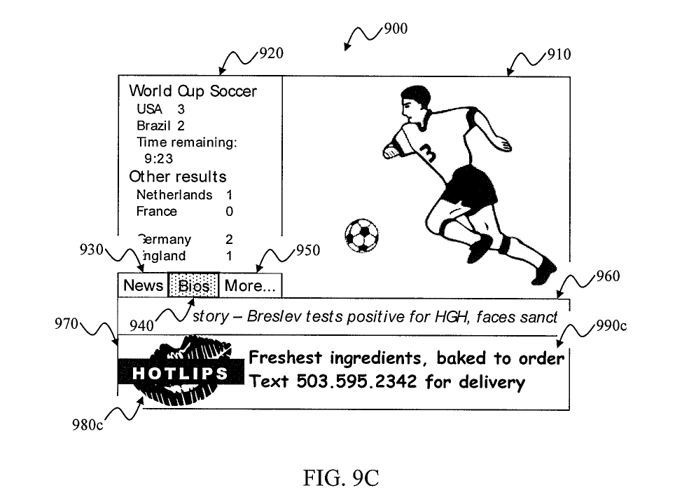

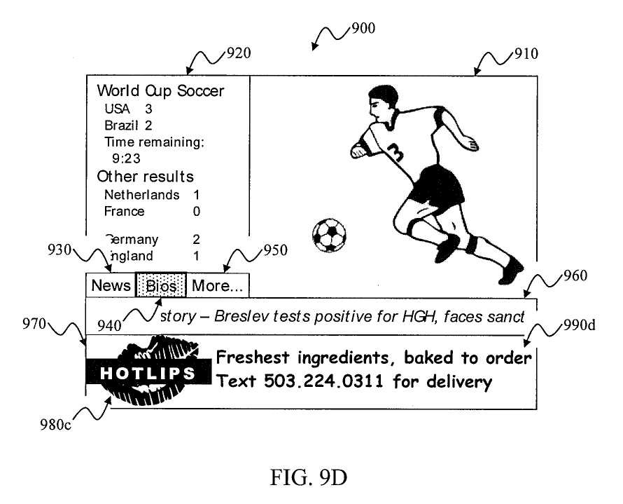

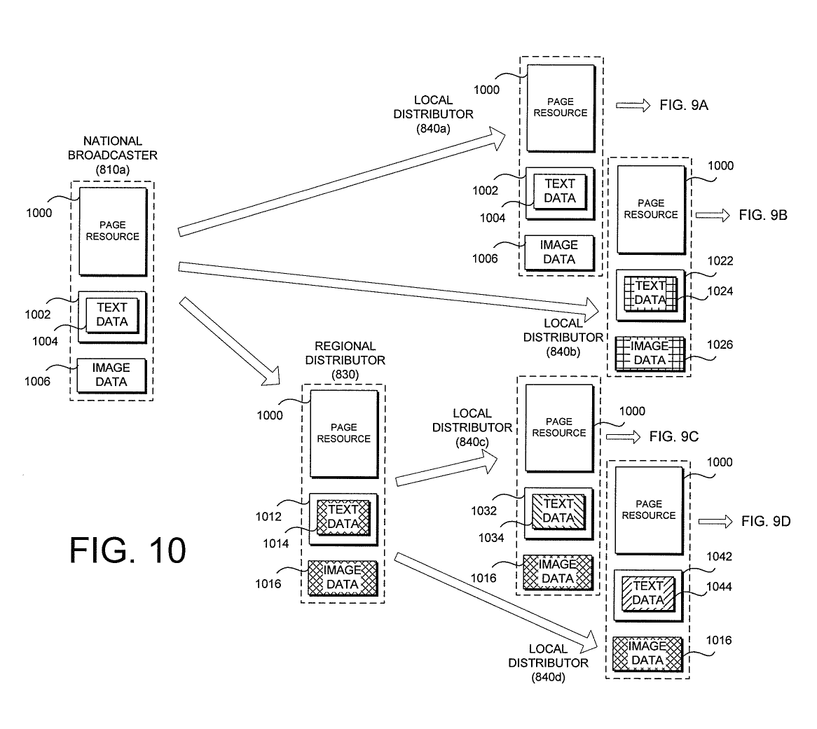

An aspect of the inventive method and system is further illustrated in FIG. 9A, FIG. 9B, FIG. 9C, and FIG. 9D which depict multiple versions of display image 900 created by an exemplary ETV-BIF iTV application. The exemplary application displays streaming video program content 910 in a portion of the display screen. The exemplary application further provides additional graphical content and allows for viewer interaction. Frame 920 displays current score information and frame 960 displays scrolling text content. The lower portion 970 of the display is reserved for advertising content comprising an image 980a, 980b, 980c and text 990a, 990b, 990c, 990d. The application provides viewer interaction by allowing navigation among buttons 930, 940, 950 using a remote control device or other means known in the art. A viewer may navigate for example to a selected button 940 and display additional content (not shown) by pressing a selection button on a remote control device or by other means known in the art. The differing image content 980a, 980b, 980c and text content 990a, 990b, 990c, 990d result from the use of different resource data when displaying the respective display image 900.

When a broadcast stream is received by a distributor and the broadcast stream includes one or more resources that may be replaced in accordance with one aspect of the current invention, the distributor may elect to replace none, some or all of the replaceable resources.

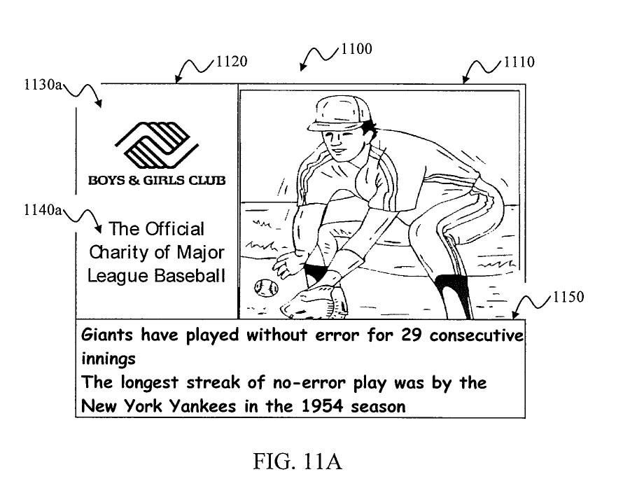

FIG. 10 depicts, by way of further illustration of the inventive method and system, an exemplary ETV-BIF encoding of the application shown in FIGS. 9A, 9B, 9C, 9D. In this example, the application is encoded using three modules; an ETV-BIF page resource 1000; an ETV-BIF data resource 1002 that includes a generic data table 1004 containing the text content 990a to be displayed in region 970; and an image resource 1006 containing encoded image data 980a to be displayed in region 970. In this example, the original versions 1000, 1002, 1006 of these modules are broadcast by national broadcaster 810a directly to regional distributor 830 and to local distributors 840a and 840b. At local distributor 840a the resources 1000, 1002, 1006 are not modified but are broadcast to local service area 850a as received from national broadcaster 810a, and upon execution the application produces the display content shown in FIG. 9A. At local distributor 840b the page resource 1000 is not modified, but original data resource 1002 is replaced with replacement data resource 1022 containing replacement generic data table 1024 encoding text content 990b, and original image resource 1006 is replaced with replacement image resource 1026 containing replacement image content 980b. The modified contents are broadcast to local service area 840b, and upon execution the application produces the display content shown in FIG. 9B. At regional distributor 830, page resource 1000 is not modified but original data resource 1002 is replaced with replacement resource 1012 containing generic data table 1014, and original image resource 1006 is replaced with replacement image resource 1016 containing replacement image content 980c. The resulting stream is broadcast to local distributors 840c, 840d. At local distributor 840c original page resource 1000 is not modified, and replacement image resource 1016 is not modified, but replacement data resource 1012 is further replaced with replacement data resource 1032 containing replacement generic data table 1034 encoding text content 990c. The modified contents are broadcast to local service area 840c, and upon execution the application produces the display content shown in FIG. 9C. At local distributor 840d original page resource 1000 is not modified, and replacement image resource 1016 is not modified, but replacement data resource 1012 is further replaced with replacement data resource 1042 containing replacement generic data table 1044 encoding text content 990d. The modified contents are broadcast to local service area 840d, and upon execution the application produces the display content shown in FIG. 9D

The foregoing discussion of resource encoding replacement is meant to be exemplary and should not be interpreted to restrict the types and extent of resource encoding, replacement and modification. As such, other sequences and combinations of resource encoding, replacement and modification are meant to fall within the spirit and intent of the inventive method and system.

Advertising Sub-Avails

An interactive application that is implemented so as to choose among two or more alternate versions of resource content provides the opportunity for advertising sub-avails, as the application can choose to utilize one or another of the alternate versions of resource content depending on business rules embodied in the application. In this case, default resource content may be displayed under one set of circumstances, while alternate resource content may be displayed under another set of circumstances.

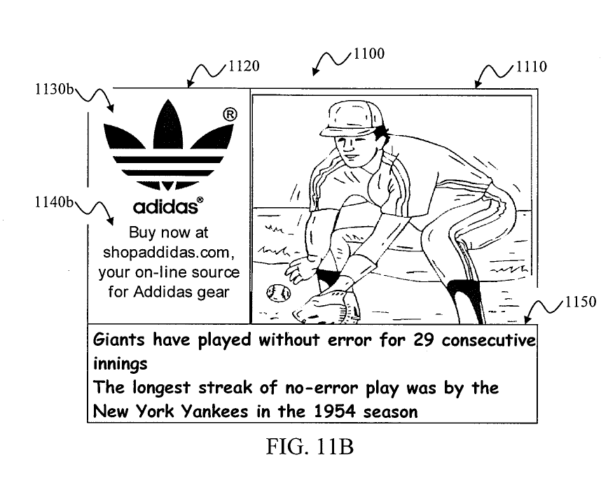

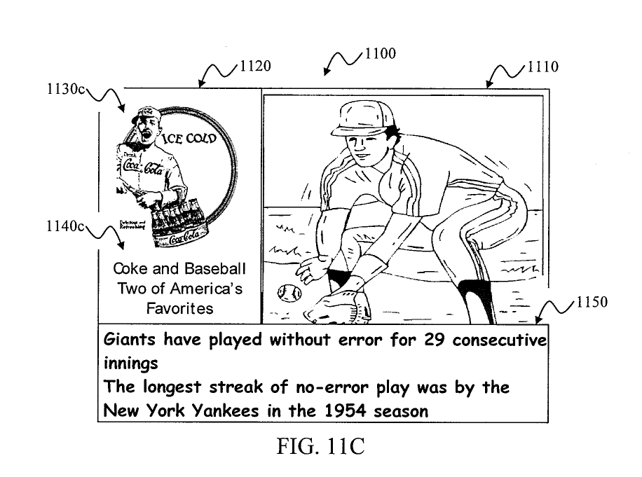

An example of how this feature may be utilized in an application is shown in FIGS. 11A, 11B, and 11C, which depict three alternate views of an interactive application 1100 that displays video, textual updates, and an advertisement. The display of application 1100 includes a panel 1110 showing streaming video content; a panel 1120 showing an advertisement comprising image content 1130a, 1130b, 1130c and textual content 1140a, 1140b, 1140c; and a panel 1150 showing textual content.

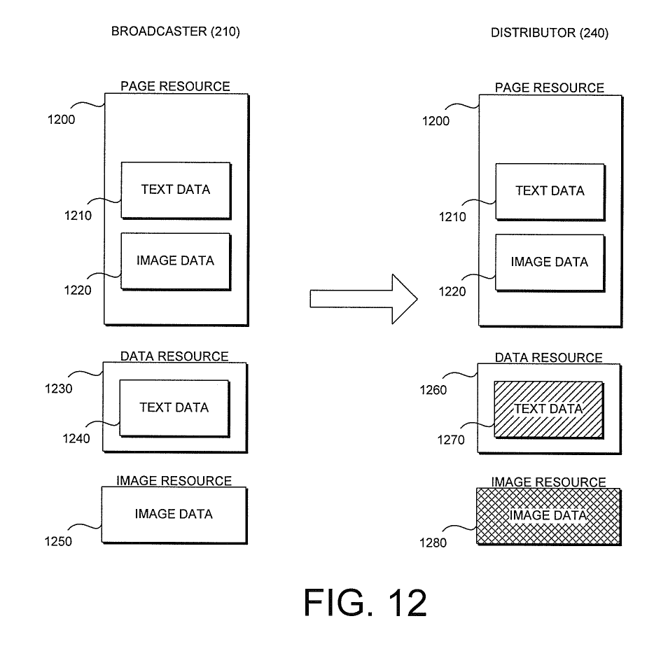

FIG. 12 depicts an exemplary encoding of the resources for application 1100 which may consist of a page resource 1200 containing first text data 1210 and first image data 1220, a data resource 1230 containing second text data 1240, and an image resource 1250 containing second image data. For the original application resources broadcast by broadcaster 210, first image data 1220 may correspond to image 1130a, first text data 1210 may correspond to textual content 1140a, second image data 1250 may correspond to image 1130b, and second text data 1240 may correspond to textual content 1140b. When application 1100 executes, the application may make a choice between displaying first image content 1130a and first textual content 1140a as shown in FIG. 11A, or displaying second image content 1130b and second textual content 1140b as shown in FIG. 11B. FIG. 12 further shows an exemplary case of resource replacement at distributor 240, where original data resource 1230 is replaced by replacement data resource 1260 containing replacement data 1270 encoding textual content 1140c, and original image resource 1250 is replaced by replacement image resource 1280 encoding image content 1130c. When application 1100 is executed with the replacement resources 1260, 1280 the application may display image content 1130a and textual content 1140a as shown in FIG. 11A, or may display image content 1130c and textual content 1140c as shown in FIG. 11C. The choice of which image and text content is displayed may be made by business rules embodied in application 1100 or accessible by application 1100.

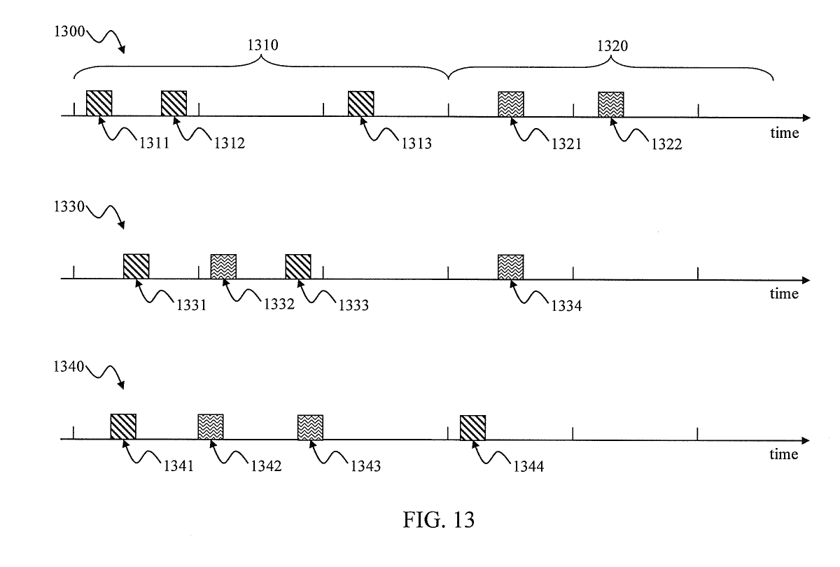

FIG. 13 depicts three exemplary business rules that might be used to determine the use of alternate sets of resources in an application such as that depicted in FIGS. 11A, 11B, and 11C. A first exemplary time line 1300 depicts a rule by which all presentations in a first time interval 1310 use a first set of resources, and all presentations in a second time interval 1320 use a second set of resources. Each separate presentation 1311, 1312, 1313 in the first interval and 1321, 1322 in the second interval may be a result of a new invocation of the application, or a result of navigation to a given page within the application, or by other means that cause the selection of a set of resources to be used when creating the display.

A second exemplary time line 1330 depicts a rule by which successive utilizations of the resources are apportioned to different sets of resources. Time line 1330 depicts the case where a different set of resources is used for each successive presentation, so that presentation 1331 and 1333 use a first set of resources and presentation 1332 and 1334 use a second set of resources. Other more complex sequencing rules may be defined, for example, by presenting a first set of resources on two successive presentations then presenting a second set of resources on a third successive presentation, the pattern repeating after the third presentation. In the illustrated timeline 1330 the ordering is based on invocations within a single application execution environment, but the ordering may also be based on invocations across multiple execution environments with coordination of presentation among the environments, for example by each application recording its activity with a central server and receiving an indication from the server as to the appropriate resource set to use, the indication being generated at the server based on a business rule and a record of prior application activity.

A third exemplary time line 1340 depicts a rule by which successive utilizations of the resources are apportioned based on a stochastic algorithm, such that on a given fraction F of presentations a first set of resources is used and for a given fraction (1-F) of presentations a second set of resources is used. In this exemplary case presentations 1341 and 1344 use a first set of resources while presentations 1342 and 1343 use a second set of resources.

The foregoing description is intended to be an illustrative but not limiting description of aspects of the inventive method and system. The timelines and business rules depicted in FIG. 13 are intended to be schematic and no limitation is to be inferred or deduced from the illustrated duration, frequency, or ordering of the presentations. Those skilled in the art will recognize that the business rules and application behavior described above may be extended to include multiple display contexts and more that two different sets of resources. For example, an application may utilize two or more sets of resources in two or more display contexts, with two or more default sets of resources some or all of which may suitable for replacement at a distributor. Different business rules may be applied to different sets of replacement resources within a single application.

Those skilled in the art will further recognize that more complex business rules may be devised. For example, a business rule may additionally or alternately take into consideration characteristics of a viewer such as age, sex, address, viewing history, prior purchase history, expressed or inferred preferences, and/or other personal profile data when determining which of two or more resources to display in a given context. A business rule may additionally or alternatively take into consideration the location and/or environs of the receiver component. A business rule may further be determined or modified by the contents of a replacement resource.

Those skilled in the art will further recognize that the encoding of application resources may take other forms than that described above for ETV-BIF applications without departing from the spirit and intent of the current invention.

Those skilled in the art will further recognize that the inventive feature of application resource replacement may be performed more than once during the distribution of a broadcast stream, with a first replacement being performed at a first distributor, the resulting modified broadcast stream being supplied to a second distributor whereupon a second replacement is performed, the process optionally being repeated until the resulting multiply-modified broadcast stream is finally distributed to one or more receiver sites. At any replacement step, a distributor may replace some but not all of the replaceable resources.

Those skilled in the art will further recognize that in the foregoing discussion, the term “broadcast” may be replaced with the term “multicast” or the term “unicast” mutatis mutandis without departing from the spirit and intent of the current invention.

In a further alternative embodiment of the inventive method and system the audio-video and interactive application content are provided by a video-on-demand (VOD) or other non-linear broadcast, multicast, or unicast system in response to a viewer request for audio-video content, whereupon audio-video and interactive application content are supplied to a distributor at which the inventive feature of application resource replacement is applied as described above to utilize one or more replacement resources in substitution for one or more original resources provided by a non-linear broadcast system, the audio-video content and modified interactive application content thereafter being supplied to one or more broadcast, multicast, or unicast receivers. In this further alternative embodiment, the interactive application may be related to primary audio-video content selected in response to a viewer request, or may be related to secondary advertising content inserted into primary audio-video content selected in response to a viewer request. The selection of the secondary advertising content and the interactive application may be based on information conveyed in the viewer request for audio-video content, or on stored or retrieved characterization data related to information conveyed in the viewer request.

The features of selector, broadcast, receiver, replacement, distribution, display and execution means as described herein may be provided by hardware, software, or a combination of hardware and software, and may be manually, semi-automatically, or automatically controlled and/or performed. Various means may be incorporated into one or more physical devices, or may be provided as wired or wireless network services. Those skilled in the art will realize that such variations in implementation do not depart from the spirit and scope of the invention. Delivery of content through a network may be accomplished by wired or wireless means, including terrestrial, satellite, cable, and telephone transmission, without departing from the intent of the inventive method and system.

The term “computer” is used herein to refer to any device with processing capability such that it can execute instructions. Those skilled in the art will realize that such processing capabilities are incorporated into many different devices and therefore the term “computer” includes PCs, servers, mobile telephone, personal digital assistants and many other devices.

The methods described herein may be performed by software in machine readable form on a storage medium. The software can be suitable for execution on a parallel processor or a serial processor such that the method steps may be carried out in any suitable order, or simultaneously.

The description acknowledges that software can be a valuable, separately tradable commodity. The description is intended to encompass software, which runs on or controls ‘dumb’ or standard hardware, to carry out the desired functions. It is also intended to encompass software which ‘describes’ or defines the configuration of hardware, such as HDL (hardware description language) software, as is used for designing silicon chips, or for configuring universal programmable chips, to carry out desired functions.

The steps of the methods described herein may be carried out in any suitable order, or simultaneously where appropriate. Aspects of any of the examples described above may be combined with aspects of any of the other examples described to form further examples without losing the effect sought.

While preferred embodiments of the invention have been illustrated and described, as noted above, many changes can be made without departing from the spirit and scope of the invention. Accordingly, the scope of the invention is not limited by the disclosure of a preferred embodiment. Instead, the invention should be determined entirely by reference to the claims that follow.

What is claimed is:

1. In a computer system providing a multimedia distribution and execution environment, a method of creating and distributing a multimedia presentation characterized by:
in a distribution environment:
receiving broadcast audio-video content with an interactive application utilizing at least one resource;
replacing at least one resource of the interactive application with a replacement resource; and
distributing the audio-video content and the interactive application with the replacement resource; and
at a receiver:
receiving the distributed audio-video content and the interactive application with the replacement resource;
displaying the audio-video content; and
in response to an external signal, executing the interactive application utilizing the replacement resource.

2. The method of claim 1, further including the step of generating the replacement resource after receiving the broadcast audio-video content in the distribution environment.

3. The method of claim 1, further characterized by the external signal being a control signal distributed with the interactive application.

4. The method of claim 1, further characterized by the external signal being a signal generated by a viewer.

5. The method of claim 1, further characterized by:
in a broadcasting environment:
selecting audio-video content;
selecting an interactive application utilizing at least one resource; and
broadcasting the interactive application in conjunction with the audio-video content downstream to the distribution environment.

6. The method of claim 1, further characterized by:
in a video server environment:
receiving a request for audio-video content;
selecting audio-video content based on the request;
selecting an interactive application utilizing at least one resource; and
broadcasting the interactive application in conjunction with the selected audio-video content downstream to the distribution environment.

7. A system for creating and distributing a multimedia presentation comprising:
a broadcast-receiver means configured to receive broadcast audio-video content with an interactive application;
a replacement means configured to replace at least one resource of the received interactive application with a replacement resource;
a distribution means configured to distribute the audio-video content and the interactive application with the replacement resource.
a receiver means configured to receive the distributed audio-video content and interactive application with the replacement resource;
a display means configured to display the audio-video content; and
an execution means configured to execute, in response to an external signal, the interactive application utilizing the replacement resource.

8. The system of claim 7, further including generation means for generating the replacement resource after receipt of the audio-video content and interactive application by the broadcast-receiver means.

9. The system of claim 7, further characterized by the external signal being a control signal distributed with the interactive application.

10. The system of claim 7, further characterized by the external signal being a signal generated by a viewer.

11. The system of claim 7, further comprising:
a content-selector means configured to select audio-video content;
an application-selector means configured to select an interactive application utilizing at least one resource; and
a broadcast means configured to broadcast the interactive application in conjunction with the selected audio-video content downstream to the broadcast-receiver means.

12. The system of claim 11, further characterized by the application-selector means selecting an interactive application related to the selected audio-video content.

13. The system of claim 7, further comprising:
a video-server means configured to receive a request for audio-video content;
a content-selector means configured to select audio-video content based on the request for audio-video content;
an application-selector means configured to select an interactive application utilizing at least one resource; and
a broadcast means configured to broadcast the interactive application in conjunction with the selected audio-video content.

14. The system of claim 13, further characterized by the application-selector means configured to select an interactive application related to the selected audio-video content.

15. The system of claim 7, further comprising:
a video-server means configured to receive a request for audio-video content;
a content-selector means configured to select audio-video content based on the request for audio-video content;
an advertisement-selector means configured to select advertisement content;
an advertisement-insertion means configured to insert the selected advertisement content into the selected audio-video content;
an application-selector means configured to select an interactive application utilizing at least one resource; and
a broadcast means configured to broadcast the interactive application in conjunction with the selected audio-video content.

16. The system of claim 15, further characterized by the application-selector means configured to select an interactive application related to the selected advertisement content.

17. A method for configuring an interactive application for delivery over a network to a viewer, the method comprising:
receiving audio-video content and an interactive application over a network from an upstream broadcaster, said interactive application having associated therewith at least one original resource;
replacing the original resource of the interactive application with a first replacement resource; and
transmitting the audio-video content and interactive application with the first replacement resource downstream through the network to multiple receivers simultaneously.

18. The method of claim 17, further including the steps of:
receiving the audio-video content and interactive application with the first replacement resource at the multiple receivers;
displaying the audio-video content; and
executing the interactive application at the multiple receivers using the first replacement resource responsive to an external signal.

19. The method of claim 17, further including the steps of:
receiving a request for audio-video content from a downstream receiver of such content; and
transmitting the audio-video content and interactive application with the first replacement resource responsive to the request.

20. The method of claim 17, further including the steps of:
receiving at a second location the audio-video content and the interactive application having the original resource from an upstream broadcaster;
replacing the original resource of the interactive application with a second replacement resource, different from the first replacement resource; and
transmitting the audio-video content and interactive application with the second replacement resource downstream through the network.
